(19) United States
(12) Patent Application Publication
(10) Pub. No.: US 2023/0284830 A1
(43) Pub. Date: Sep. 14, 2023

(54) OUTDOOR OVEN WITH MODIFIABLE PORTABILITY, SYSTEM AND METHOD THEREOF

(71) Applicant: North Atlantic Imports, LLC, Logan, UT (US)

(72) Inventors: Jared M. Smith, Paradise, UT (US); John C. Dunker, Providence, UT (US)

(21) Appl. No.: 18/110,730

(22) Filed: Feb. 16, 2023

Related U.S. Application Data
(60) Provisional application No. 63/311,032, filed on Feb. 16, 2022.

(51) Int. Cl. A47J 37/07

(52) U.S. Cl. CPC A47J 37/0786; A47J 37/0713

(57) ABSTRACT

A cooking system with modifiable portability that includes an outdoor oven and a stand. The outdoor oven extends with an upper oven portion and a lower oven portion. The upper oven portion includes a cooking chamber having a lower stone positioned on a tray. The lower oven portion includes oven legs extending therefrom. The stand includes a frame structure extending between an upper side and a lower side, the frame structure sized and configured to receive the oven legs of the outdoor oven so that the outdoor oven is positionable over the stand. The stand includes wheels positioned adjacent the lower side of the stand. The outdoor oven being removable from the frame structure of the stand to separate the outdoor oven from the stand so that the outdoor oven is useable in a countertop configuration.

### CROSS-REFERENCE TO RELATED APPLICATIONS

This application claims the benefit of U.S. Provisional Application No. 63/311,032, filed Feb. 16, 2022, the disclosure of which is hereby incorporated by reference herein in its entirety.

### TECHNICAL FIELD

The present invention relates generally to outdoor cooking systems and, more specifically, the present invention relates to an outdoor oven type cooking system for baking or cooking food with modifiable portability and structure for minimizing the heating of portions of the cooking system.

### BACKGROUND

The ability to cook outdoors has become popular, and as such there have been many different devices designed for outdoor cooking such as outdoor kitchens and various portable cooking systems. Outdoor ovens have become popular due to their ability to cook foods, such as pizza, bread or pasta dishes, that are not readily cooked in typical grill type cooking stations. Many outdoor ovens are intended to be stationary or are structurally limited to be readily positioned in certain types of locations, making it difficult to readily move the outdoor oven from one site to the next. Further, the ability to maintain heat at high temperatures without damaging components of the oven while also minimizing the temperature of the external surface of the oven has proven difficult.

### BRIEF SUMMARY OF THE INVENTION

The present invention is directed to various embodiments of an outdoor oven, system or method. In one embodiment, an outdoor oven with temperature control is provided. The outer oven includes an upper oven portion and a lower oven portion. The upper oven portion includes an outer shell extending to surround a cooking chamber. The cooking chamber is defined by an upper stone, a lower stone and a heat shield. The heat shield extends downward from the upper stone to partially surround a periphery of the lower stone, the heat shield positioned within the outer shell such that a gap is defined between the heat shield and the outer shell. The outer shell includes a shell floor extending between opposing sides of a lower end of the outer shell. The shell floor includes a burner opening defined therein, and the heat shield extends toward the shell floor. The outer shell extends to define a front opening sized to access the cooking chamber. The outer shell includes multiple vent holes defined therein and adjacent the lower end of the outer shell, the vent holes sized and configured to draw air into the gap defined between the heat shield and the outer shell. The lower oven portion includes a burner knob coupled thereto, the burner knob coupled to a burner such that the burner is positioned at least partially below the burner opening defined in the lower floor of the upper oven portion, the lower oven portion positioned below the upper oven portion with a spaced gap therebetween such that the spaced gap is sized to minimize heating the lower oven portion.

In another embodiment, the heat shield includes an upper heat shield and a lower heat shield, the lower heat shield positioned below the lower stone with the upper heat shield extending upward directly from the lower heat shield. In a further embodiment, the lower heat shield is positioned on the shell floor and extends with a band configuration, the upper heat shield having a partial truncated cone shape positioned over the lower heat shield.

In another embodiment, the upper oven portion includes a cover, the cover positionable over the outer shell. In another embodiment, the upper oven portion includes a cover, the cover including a dual wall with a cover gap defined therebetween, the cover extending above the outer shell and the upper stone.

In another embodiment, the burner is configured to burn fuel so that heat flows upward against the lower stone and through a heat gap between the periphery of the lower stone and the heat shield to flow into the cooking chamber to heat the upper stone. In another embodiment, the lower stone is configured to rotate with a motor associated with the lower housing, the lower stone positioned on a tray with an axle extending between the motor and the tray. In still another embodiment, the heat shield includes a stainless-steel material. In another embodiment, the upper oven portion is suspended above the lower oven portion with spacers to define the spaced gap therebetween.

In accordance with another embodiment of the present invention, a cooking system with modifiable portability is provided. The cooking system includes an outdoor oven and a stand. The outdoor oven extends with an upper oven portion and a lower oven portion. The upper oven portion includes the cooking chamber having a lower stone positioned on a rotatable tray, the tray rotatable about an axis. The lower oven portion includes oven legs extending therefrom. The stand includes a frame structure extending between an upper side and a lower side, the frame structure sized and configured to receive the oven legs of the outdoor oven so that the outdoor oven is positionable over the stand. The stand includes wheels positioned adjacent the lower side of the stand. With this arrangement, the outdoor oven is removable from the frame structure of the stand to separate the outdoor oven from the stand so that the outdoor oven is useable in a countertop configuration.

In another embodiment, upon the outdoor oven being positioned on the stand, the outdoor oven is removable by moving the outdoor oven upward along the axis. In another embodiment, the upon the outdoor oven being positioned on the stand, the outdoor oven is prevented from being moved laterally relative to the axis.

In another embodiment, the outdoor oven extends with an upstanding outer panel and a cover, the cover positioned over the upstanding outer panel so as to define a chamber opening for accessing the cooking chamber, the cover extending with a cover exterior wall and a cover inner wall with a cover space defined therebetween, the cover inner wall and the cover space sized and configured to minimize heating the exterior wall.

In still another embodiment, the upper oven portion extends with an outer shell having a shell floor, the upper oven portion including an upper heat shield and a lower heat shield to minimize heating the outer shell, the upper heat shield at least partially defining the cooking chamber, the upper heat shield extending to partially surround a periphery of the lower stone and extending to overlap a portion of the lower heat shield such that the lower heat shield is positioned along the shell floor. In another embodiment, the upper oven portion extends with an outer shell, the upper oven portion including a heat shield positioned to provide a gap defined between the outer shell and the heat shield, the outer shell defining multiple vent openings defined therein adjacent a lower end of the outer shell, the multiple vent openings sized and configured to draw air therethrough and into the gap to cool the outer shell of the upper oven portion. In another embodiment, the lower oven portion is positioned below the upper oven portion with a spaced gap defined therebetween such that the spaced gap is sized to minimize heating the lower oven portion.

In accordance with another embodiment of the present invention, a method of modifying portability of an outdoor oven is provided. The method includes the steps of: providing the outdoor oven extending with an upper oven portion and a lower oven portion, the upper oven portion including the cooking chamber having a lower stone positioned on a rotatable tray, the tray rotatable about an axis, the lower oven portion including oven legs extending therefrom; positioning the outdoor oven over a stand such that the oven legs are receivable by frame structure of the stand to maintain the outdoor oven in an elevated position on the stand; and separating the outdoor oven from the stand by moving the outdoor oven upward along the axis so that the outdoor oven is useable in a countertop configuration.

In another embodiment, the positioning step includes moving the stand with the outdoor oven positioned thereon with wheels coupled to a lower end of the stand. In another embodiment, the method further includes heating the cooking chamber for cooking with the outdoor oven such that the outdoor oven is either (1) coupled to the stand in the elevated position, or (2) separated from the stand with the outdoor oven in the countertop configuration. In another embodiment, the providing step includes providing the upper oven portion suspended above the lower oven portion with a spaced gap defined therebetween, the spaced gap configured to minimize heating components of the lower oven portion.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective front view of an outdoor oven, according to an embodiment of the present invention;

FIG. 2 is a perspective rear view of the outdoor oven, according to another embodiment of the present invention;

FIG. 3 is a partially exploded view of the outdoor oven, depicting an oven portion disengaged from a stand portion of the outdoor oven, according to another embodiment of the present invention;

FIG. 4 is an exploded view of the outdoor oven, according to another embodiment of the present invention;

FIG. 5A is a partial cross-sectional view of the outdoor oven taken along section line A-A of FIG. 1, according to another embodiment of the present invention;

FIG. 5B is a partial cross-sectional view of the outdoor oven taken along section line B-B of FIG. 1, according to another embodiment of the present invention;

FIG. 6 is a front view of the oven portion of the outdoor oven, according to another embodiment of the present invention;

FIG. 7 is a side view of the oven portion of the outdoor oven, according to another embodiment of the present invention;

FIG. 8 is a bottom view of the oven portion of the outdoor oven, depicting a holding structure and motor of the outdoor oven, according to another embodiment of the present invention;

FIG. 8A is an enlarged perspective view of the holding structure and the motor, according to another embodiment of the present invention;

FIG. 8B is an enlarged perspective view of the holding structure and the motor, according to another embodiment of the present invention;

FIG. 8C is an enlarged perspective view of the holding structure and the motor, according to another embodiment of the present invention;

FIG. 8D is an enlarged perspective view of the holding structure and the motor, according to another embodiment of the present invention;

FIG. 9 is a partially exploded view of another embodiment of an outdoor oven, depicting the motor and components thereof disassembled from the outdoor oven, according to the present invention;

FIG. 10 is a perspective view of the motor, depicting a flange associated with the motor, according to another embodiment of the present invention;

FIG. 11 is a perspective view of the outdoor oven with the motor attached thereto, according to another embodiment of the present invention;

FIG. 11A is a cross-sectional view of the outdoor oven, depicting a shaft in a disengaged position relative to the motor, according to another embodiment of the present invention; and

FIG. 11B is a cross-sectional view of the outdoor oven, depicting the shaft engaged with the motor, according to another embodiment of the present invention.

### DETAILED DESCRIPTION OF THE INVENTION

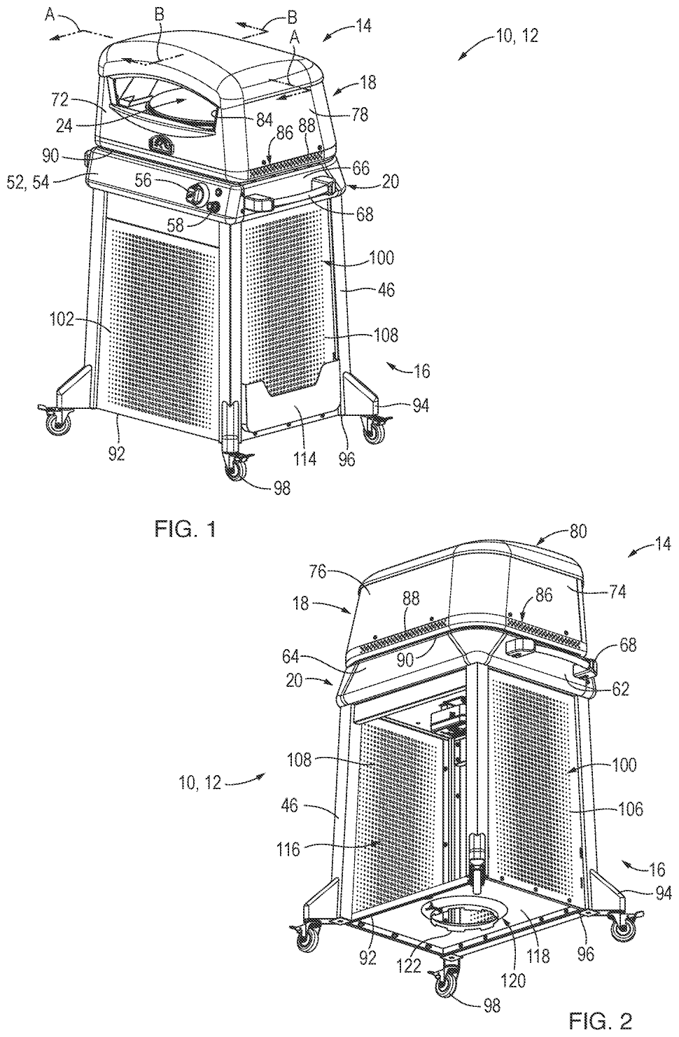

Referring to FIGS. 1, 2 and 3, an outdoor oven 10 or cooking system 12 with modifiable portability and/or heat efficiency is provided. In one embodiment, the outdoor oven 10 may include an oven portion 14 and a stand portion 16 such that the outdoor oven 10 may be employed in a stand configuration or elevated position and may readily be moved to a desired position along a deck or patio floor in its stand configuration. In another embodiment, the oven portion 14 may readily be moveable to and from, as shown by bi-directional arrow 15, relative to the stand portion 16 so that the oven portion 14 of the outdoor oven 10 may be employed in the elevated stand configuration or a countertop configuration such that the outdoor oven 10 may be positioned to sit directly on a countertop or table top, or the like. In other words, the outdoor oven 10 may be employed in the countertop configuration and the stand configuration so that the user may utilize the outdoor oven 10 at an outdoor location that best suits the desires and needs of the user. Further, the outdoor oven 10 may include similar structure to the various oven embodiments disclosed in commonly owned U.S. Pat. No. 10,413,123 to Dahle et al., the disclosure of which is incorporated by reference herein in its entirety. In another embodiment, the outdoor oven 10 may include structure therein to maintain high temperatures in the oven while also minimizing temperatures of the external surface of the outdoor oven 10 or functional components of the oven 10, set forth in further detail herein.

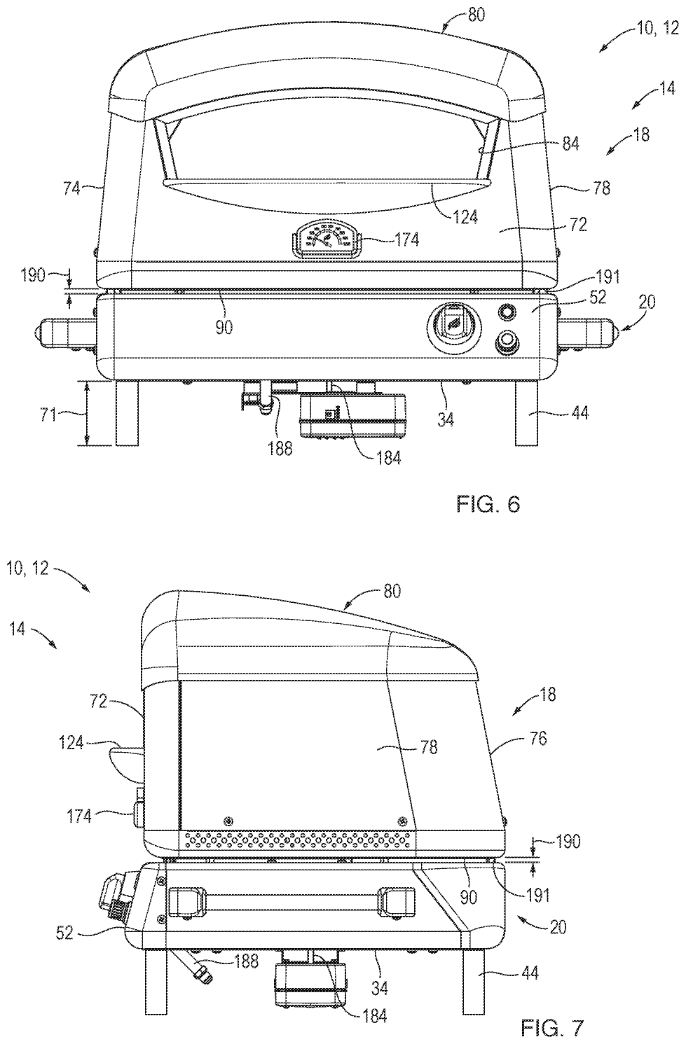

Now with reference to FIGS. 1-4, as previously set forth, the cooking system 12 may include the oven portion 14 and the stand portion 16. The oven portion 14 may be sized and configured to sit or be positioned over a top end 50 or top side of the stand portion 16. Further, the oven portion 14 may include an upper oven portion 18 and a lower oven portion 20. The oven portion 20 may be designed to control the heat therein so that the temperature of the lower oven portion 20 and the external surface of the upper oven portion 18 is minimized. The lower oven portion 20 may include a front panel 52 where the front panel 52 may also be a control panel 54. The control panel 54 may include a burner knob 56 and an ignition button 58 each coupled to structure positioned within the lower oven portion 20 or associated with the lower oven portion 20 to facilitate heating the upper oven portion 18, such as various types of valves, conduit and various other structure, such as a spark ignitor, as known to one of ordinary skill in the art. For example, the burner knob 56 may be turned to various positions to open a gas valve (not shown) to various corresponding open positions to facilitate variations of gas flow to and through a burner 60 (FIG. 5A). The user may then ignite the gas at the burner 60 by pushing or activating the ignition button 58, as known to one of ordinary skill in the art. The components of the oven portion 14 may be sized and configured to be heated with propane gas or natural gas, for example, as its fuel source. In conjunction with a high pressure regulator (not shown) associated with the fuel source, the burner 60 may be the type that is adjustable and is a high pressure output burner or high gas flow burner, such as up to 5.0 psi, so that the cooking chamber 24 or baking chamber may heat quickly and hold high temperatures therein, such as up to 900 degrees Fahrenheit.

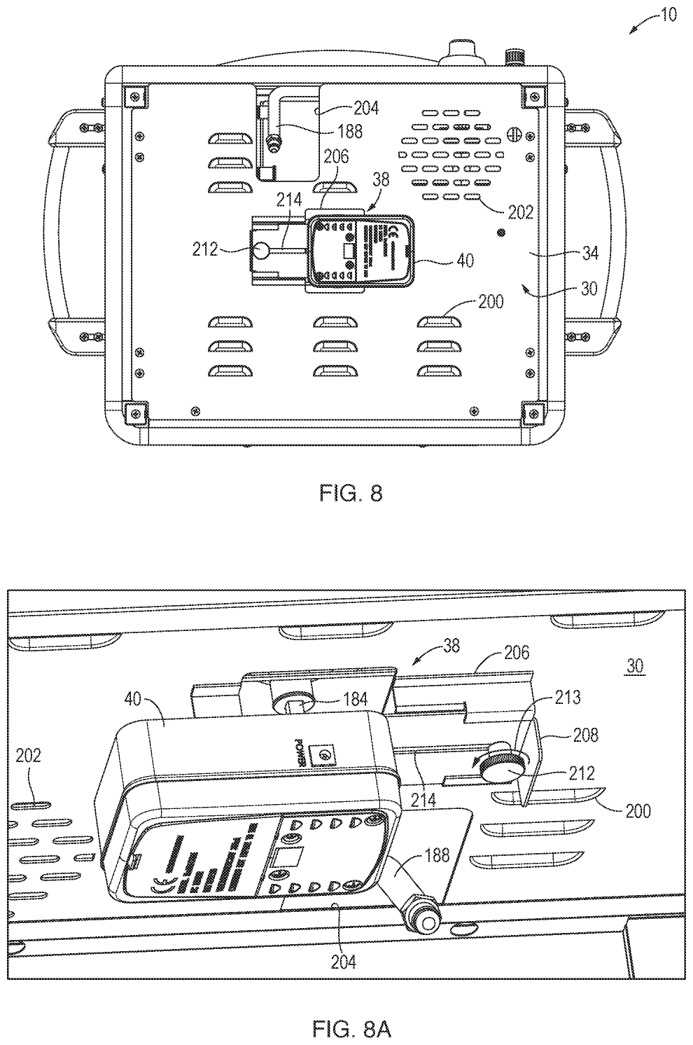

The lower oven portion 20 may be substantially enclosed with a lower panel 30 (or lower floor), a left panel 62, a rear panel 64, a right panel 66 and the front panel 52. In some embodiments, the lower oven portion 20 may include an upper panel 61. The front panel 52 may be positioned opposite the rear panel, the left panel 62 may be positioned opposite the right panel 66, and the upper panel 61 may be positioned opposite the lower panel 30. The upper panel 61 may include a bend, as depicted, so that the upper panel 61 may extend over a central portion of the lower oven portion 20. The upper panel 61 may also extend over most or the entire upper side of the lower oven portion 20. This upper panel 61 or panel may also be coupled directly to a bottom side of the upper oven portion 18, which may be referenced as a shell floor or lower side panel 26 (FIG. 5A). The left panel 62 and right panel 66 of the lower oven portion 20 may each include a side handle 68 secured thereto. Further, the lower panel 30 may extend to each of the front and rear panels 52, 64 as well as the left and right panels 62, 66 and may act as a bottom side of the oven portion 14. Further, the lower panel 30 may extend toward peripheral corner portions 70 that may define oven legs 44 each extending longitudinally to define a length 71 (FIG. 6) such that there may be four oven legs 44, one extending from each peripheral corner portion. In another embodiment, the lower panel 30 may extend with a circular shape such that the circular shaped lower panel may also include oven legs 44. The lower panel 30 of the lower oven portion 20 may include other features, such as various openings and structure attached or extending therethrough, such as a motor 40 and axle 42 (see FIGS. 5A), discussed in further detail herein.

The upper oven portion 18 may include an outer shell 22 with one or more panels. For example, the outer shell 22 may extend to define a lower side panel 26 or shell floor (see FIGS. 5A, 5B), a front side panel 72, a left side panel 74, a back side panel 76, and a right side panel 78. Further, the outer shell 22 may include a cover 80 such that the cover 80 may slightly overlap and fit around an upper end 82 of each of the front side panel 72, left side panel 74, back side panel 76, and right side panel 78. In some embodiments, the outer shell 22 may extend with a radial component such that portions of the front side panel 72, left side panel 74, back side panel 76, and/or the right side panel 78 may extend with a curvature.

Even further, the outer shell 22 of the upper oven portion 18 may be sized and configured to house various structural heat shields and components to define a cooking chamber 24 therein. The front side panel 72 of the upper oven portion 18 may extend to define a chamber opening 84, the chamber opening 84 sized and configured to facilitate positioning a food product into the cooking chamber 24. The left side panel 74, back side panel 76, and right side panel 78 may include lower vents 86 defined therein. Such lower vents 86 may be sized and configured to draw air therethrough so that air external of the outer shell 22 may move into a gap (such as lower air gap 131 and upper air gap 129, as shown by air flow arrow 133 (see FIG. 5A)) between the various structural heat shields and the outer shell 22. In this manner, upon heating the cooking chamber 24, the temperature of the outer shell 22 of the upper oven portion 18 may be cooled by the air drawn through the lower vents 86 so that the temperature of the external surface of the outer shell 22 may be minimized so as to be safer in the event someone touches the exterior of the outer shell 22. In one embodiment the lower vents 86 may be sized and configured to define multiple holes 88 in the outer shell 22. In another embodiment the lower vents 86 may be sized and configured to be vertical vents or horizontal vents. Further, the lower vents 86 may be located adjacent a lower end 90 of the outer shell 22 of the upper oven portion 18.

Now with reference again to the stand portion 16, the stand portion 16 may extend between a top end 50 and a bottom end 92. Further, the stand portion 16 may include, for example, vertically extending frame structure 46 that may generally extend a height of the stand portion 16 from the top end 50 to the bottom end 92. The frame structure 46 may be sized and configured to extend at least partially to define a hollow portion 48. In one embodiment, the frame structure 46 may extend with tubular structure to define the hollow portion 48. Further, the lower oven portion 20 may be placed directly over the top end 50 of the stand portion 16 such that the oven legs 44 may slide into the hollow portion 48 of the frame structure 46. In one embodiment the hollow portion 48 of the frame structure may extend from the top end 50 to the bottom end 92 of the stand portion 16. In another embodiment the hollow portion 48 of the frame structure 46 may extend a length 71 that may correspond with the oven legs 44 such that the oven legs 44 may be suspended within the within the hollow portion 48. Further, the oven legs 44 may be sized and configured to fit within the hollow portion 48 of the frame structure 46 such that when sliding into and sitting in the hollow portion 48 there is little or no play for the oven portion 14 to move. In this manner, upon the oven portion 14 being positioned to rest on the stand portion 16, the oven portion 14 may be substantially prevented from moving laterally relative to the stand portion 16. In one embodiment, upon the oven portion 14 being positioned to rest on the stand portion 16, the oven portion 14 may be removed by moving the oven portion 14 upward or vertically relative to the stand portion 16. In another embodiment, the frame structure 46 of the stand portion may be sized and configured to receive the oven legs 44 so that the oven portion 14 may sit on the stand portion 16 and be maintained thereto without the oven portion 14 being laterally moveable relative to the stand portion 16. In some embodiments, the stand portion 16 may include structure to receive the oven legs 44 so that an underside of the oven portion 14 may rest on a top side of the stand portion 16.

In another embodiment, the bottom end 92 of the stand portion 16 may include a wheel support 94 extending outward from each corner portion 96 of the stand portion 16 that corresponds with the frame structure 46. The wheel supports 94 may each include a locking wheel 98 sized and configured to allow for the stand portion 16 to move in multiple directions and lock in place if desired. The stand portion 16 may include one or more side panels or screens 100 extending between portions of the frame structure 46. For example, the stand portion 16 may extend to define a front screen 102, a left screen 106, and a right screen 108. Further, the one or more screens 100 may extend between the top end 50 to the bottom end 92 of the stand portion 16. The one or more panels or screens 100 and/or the frame structure 46 may be sized and configured to couple one or more utility members 114 thereto. In one embodiment, the utility member 114 may be a side tray or drawer. In another embodiment the utility member 114 may be a utensil slot sized to hold a pizza peel (not shown). The front screen 102, the left screen 106, and the right screen 108 may extend to define an open space 116 below the oven portion 14 and above the bottom end 92 of the stand portion 16, the space 116 being accessible at a rear of the stand portion 16. Further, the open space 116 may be defined between the oven portion 14 and a bottom tray 118, the bottom tray 118 located at the bottom end 92 of the stand portion 16. The bottom tray 118 may extend to corners adjacent to the stand legs 46 and extend to the one or more screens 100 such that the bottom tray 118 is positioned above the ground. Further, the bottom tray 118 may define tank holder structure 120 sized and configured to hold a propane gas tank, for example. In one embodiment the tank holder structure 120 may include a ridge 122 extending to define a circular opening in the bottom tray 118.

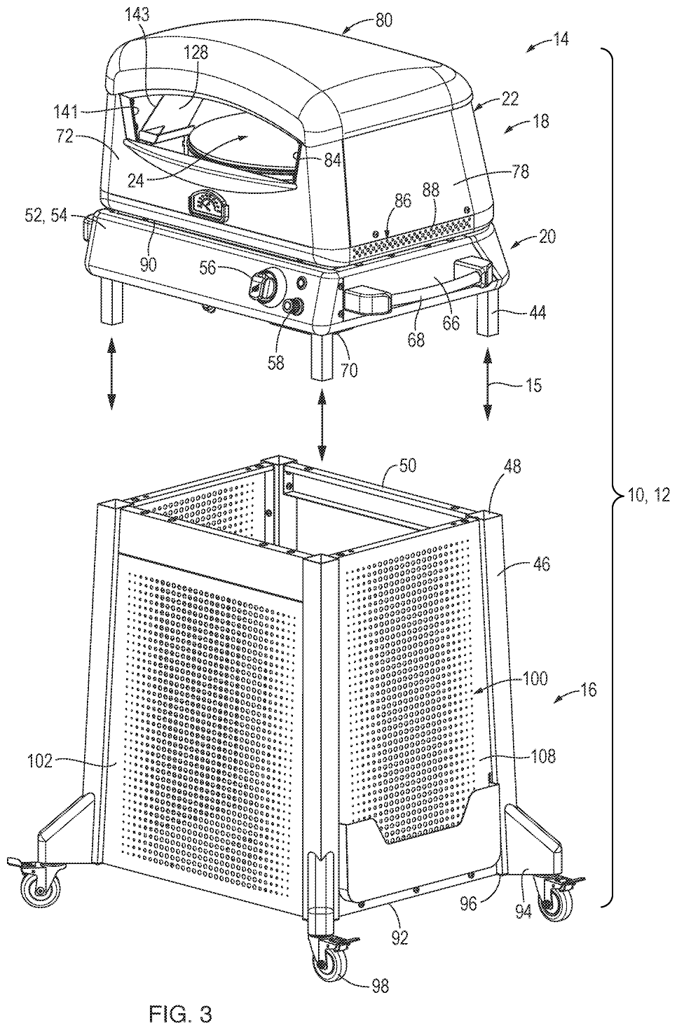

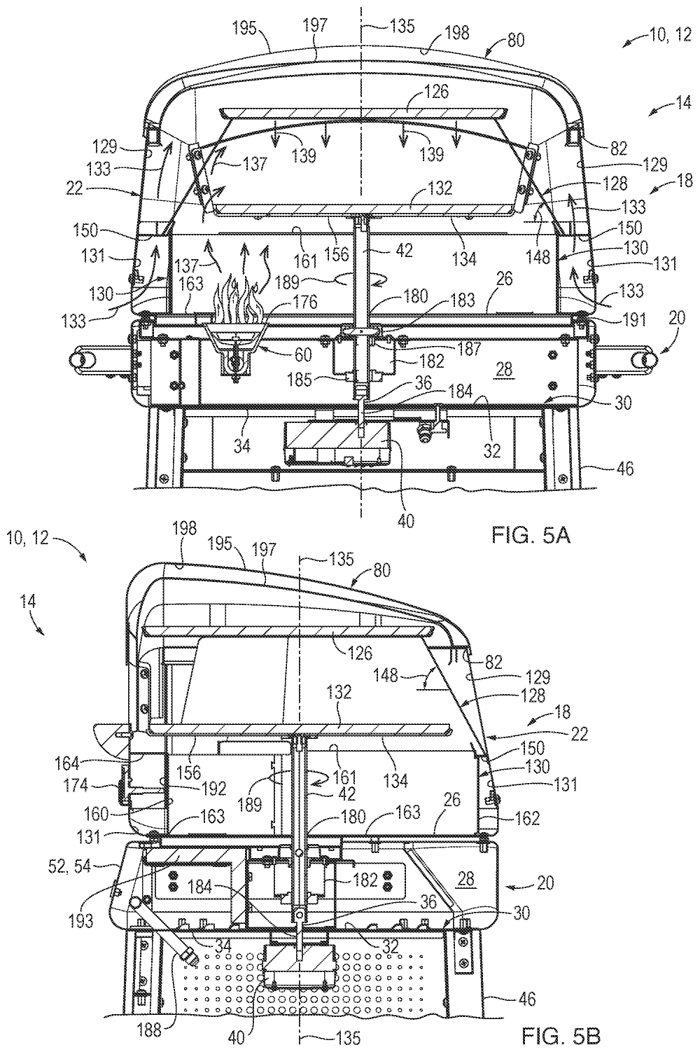

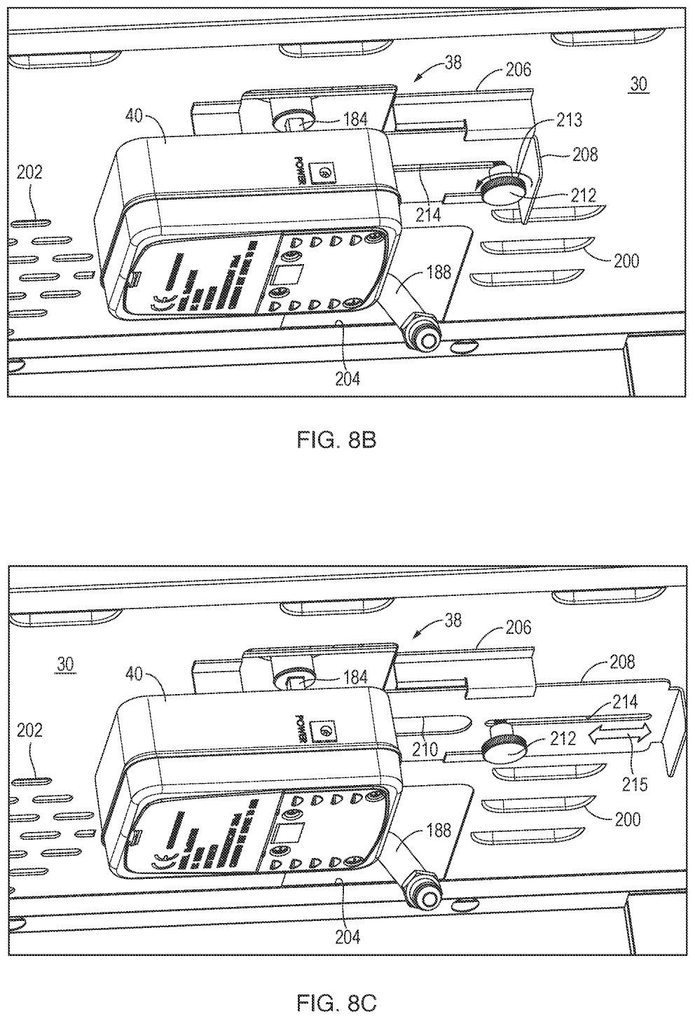

Now with reference to FIGS. 4, 5A, 5B, 6 and 7, the cooking system 12 may include the oven portion 14. The oven portion 14 may be sized and configured to be placed on the stand portion 16 such that the cooking system 12 may be at a stand height or elevated position which is suitable for the user to employ the cooking system 12. Further, the oven portion 14 may include the upper oven portion 18 and the lower oven portion 20. The upper oven portion 18 may include the outer shell 22. The outer shell 22 may extend to define the front side panel 72, the left side panel 74 (FIG. 2), the back side 76 panel (FIG. 2), and the right side panel 78 (see FIG. 2) each of which may extend between the upper and lower ends 82, 90. The cover 80 may be sized and configured to be placed over the upper end 82 of each of the front side panel 72, left side panel 74, back side panel 76 and right side panel 78 of the outer shell 22. Further, the upper cover 80 may extend to define a curved profile with rectangular or square dome shape. In one embodiment, the cover 80 may cover the upper end 82 in an overlapping arrangement. The front side panel 72 and the cover 80 may at least partially define the chamber opening 84, the chamber opening 84 being sized and configured to allow different variations of cooking utensils, such as a pizza peel, to pass therethrough. The chamber opening 84 may include a bottom lip 124 extending along a bottom side of the chamber opening 84. Further, the chamber opening 84 may extend from the lip 124 towards the upper end 82 of the outer shell 22 and may be wider so as to extend toward the left side 74 and right side 78 as the chamber opening 84 extends to the upper end 82.

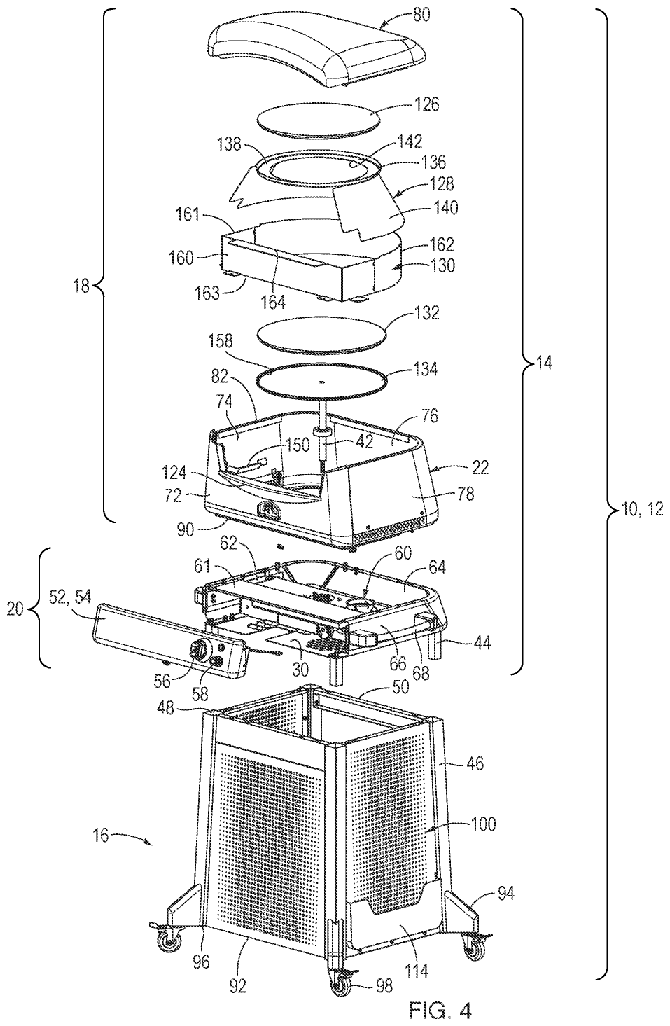

The upper oven portion 18 may include an upper stone 126, upper heat shield 128, lower heat shield 130, a lower stone 132, and a rotating tray 134. The cooking chamber 24 may be defined between the upper and lower stones 126, 132 and with the upper heat shield 128. Such cooking chamber 24 may be separated from the outer shell 22 and cover 80 with a substantial upper air gap 129 so that the temperature of the outer shell 22 and cover 80 may be minimized, upon the oven portion 14 being heated. The upper heat shield 128 may extend with a partial truncated cone shape with the upper stone 126 positioned over an upper side of the upper heat shield 128. In some embodiments, the upper stone 126 may be positioned along a ledge 138 along the upper side of the upper heat shield 128. The upper heat shield 128 may be suspended within the upper oven portion 18 with brackets 150 positioned along an interior surface of the outer shell 22 such that a lower side or lower end of the upper heat shield 128 may be positioned to rest on the brackets 150. The lower heat shield 130 may be positioned along the lower side panel 26 or shell floor of the upper oven portion 18 so as to extend upright to about the brackets 150 so that the upper heat shield 128 extends at an angle 148 so as to overlap a top end of the lower heat shield 130. Further, the lower heat shield 130 may be positioned along the lower side panel 26 in an upright position so as to provide a lower air gap 131 between the outer shell 22 and the lower heat shield 130 so that the temperature of the outer shell 22 may be minimized. Such lower air gap 131 may be contiguous with the upper air gap 129 defined at least partially by the upper heat shield 128. Further, as previously set forth, the lower vents 86 may be sized and configured to facilitate air flow through the vents 86 to be drawn into the lower gap 131 and the upper gap 129, as depicted by air flow arrow 133, as depicted in FIG. 5A. Such external air is drawn upward from the lower vents 86 while the cooking chamber 24 is being heated because heat bellows out of the front chamber opening 84 directly past an exposed gap 141 between side edges 143 of the upper heat shield 128 and the outer shell 22 (see FIG. 3). In this manner, the upper heat shield 128 and the lower heat shield 130, in conjunction with the externally drawn air flow 133, may cooperate in minimizing the temperature of the outer shell 22.

In another embodiment, the upper and lower heat shields 128, 130 may be referenced as a heat shield, which may include multiple heat shield components or a single heat shield component. In another embodiment, the heat shield or upper and lower heat shields 128, 130 may be formed from a stainless-steel material. With such stainless-steel material formed as a heat shield, the heat shield may reflect heat therefrom via the stainless-steel material having reflective characteristics as well as shield heat from the outer shell 22 and funnel heat to the cooking chamber 24. Such lower side panel 26 may also be formed of a stainless-steel material.

The upper and lower stones 126, 132 may be referenced as respective upper and lower heat sinks for radiating heat therefrom. Further, the upper and lower stones 126, 132 may be a term of art for “a pizza stone” and may be formed from a ceramic material, a cordierite material and/or a composite material or combinations/blends thereof, as known to one of skill in the art. The upper stone 126 may be sized and configured to be circular. In another embodiment the upper stone 126 may be sized and configured to be another shape such as square or rectangular, or a truncated circular shape. The upper heat shield 128 may be sized and configured to correspond with the shape of the upper stone 126 and may include a wall 136, ledge 138, and sheet 140 arrangement, such that the wall 136, ledge 138, and sheet 140 may be integrally connected. The ledge 138 may extend continuously to correspond with the upper stone 126 such that the upper stone 126 may be placed on the ledge 138. Further, the ledge 138 may extend inward from the wall 136 toward an opening 142 so that, upon the upper stone being positioned on the ledge 138, the opening 142 allows the upper stone to be exposed to the heat in the cooking chamber 24. Even further, the upper stone 126 placed on the ledge 138 at least partially defines an upper side of the cooking chamber 24. The wall 136 may extend a depth to assist in holding the upper stone 126 so as to prevent lateral movement of the upper stone 126. The sheet 140 may extend diagonally outwards from the ledge 138 and wall 136 such that the sheet 140 extends at least partially with a truncated cone shape so as to extend with a slope 148 or angle with a curvature. Further, the sheet 140 may be located below the ledge 138 and the wall 136 such that the slope 148 may direct heat upwards towards the upper stone 126. Such upper heat shield 128 may extend with the truncated cone shape, but with a portion missing or removed so that the upper heat shield 128 does not obstruct the chamber opening 84. The sheet 140 of the upper heat shield 128 may be placed within the upper portion 18 on the bracket 150 of the oven portion 14 such that the upper heat shield 128 extends to further define the cooking chamber 24. Further, the upper heat shield 128 may be positioned within the upper oven portion 18 so that the ledge 138 and upper stone 126 may be suspended to extend above the upper end 82 of the outer shell 22 and within the cover 80.

The rotating tray 134 may be directly coupled to the axle 42 and rotated and driven by a motor 40 (FIG. 5B), the motor 40 being coupled to the axle 42. The axle 42 may extend from the exterior 34 of the lower panel 30 to the rotating tray 134 such that the tray 134 may be located in the cooking chamber 24. The rotating tray 134 may rotate about an axis 135 defined along the longitudinal length of the axle 42. Such axis 135 may extend centrally through the outdoor oven 10 including each of the oven portion 14 and the stand portion 16. The tray 134 may extend to define an underside 156 of the cooking chamber 24. The lower stone 132 may be sized and configured to be circular. The lower stone 132 may be positioned on the tray 134 such that the tray 134 and lower stone 132 extend to correspond with each other. Further, the tray 134 may include a rim 158 extending to correspond with the lower stone 132.

Further, the lower heat shield 130 may be located below the cooking chamber 24 adjacent to the lower end 90 and the lower oven portion 20 such that the lower heat shield 130 is below the lower stone 132 and tray 134. The lower heat shield 130 may include a front side 160 and a back side 162. The front side 160 may exhibit a partial square profile such that the front side 160 of the lower heat shield 130 may correspond with the front side panel 72, left side panel 74, and right side panel 78 of the outer shell 22. Further, the front side 160 may include an overhang 164 extending from the front side 160 of the lower heat shield 130 towards the front side panel 72 of the outer shell 22. The lower heat shield 130 may attach to the outer shell 22 by the overhang 164 or may be attached to the lower panel 26. The back side 162 may exhibit a rounded profile such as a half circle shape. The back side 162 may be integrally attached to the front side 160 such that the lower heat shield 130 is shaped similarly to a half moon or a truncated circular shape. In this manner, the lower heat shield 130 may extend in a continuous loop or band type configuration. Further, the lower heat shield 130 may be positioned within the upper oven portion 18 so as to extend between a top end 161 and a bottom end 163, the top end 161 disposed under a lower end portion of the upper heat shield 128 and the bottom end of the lower heat shield 130 positioned on the lower side panel 26 or shell floor of the upper oven portion 18.

As previously set forth, the lower oven portion 20 may include the front panel 52, left panel 62, rear panel 64 and right panel 66. The front panel 52, left panel 62, rear panel 64, and right panel 66 may extend continuously to define an inner portion 28. The inner portion 28 may be associated with the controls necessary, as known to one of ordinary skill in the art, that may be employed with the cooking system 12, such as the burner 60, the burner knob 56 and the ignition button 58 to heat the oven portion 14. Further, the lower oven portion 20 may include the oven legs 44 that may be sized and configured to be placed through the hollow portion 48 of the frame structure 46 of the stand portion 16. The lower oven portion 20 may be positioned on the stand portion 16 such that the axis 135 may extend centrally through the stand portion 16 and lower oven portion 20. In another embodiment, the lower oven portion 20 may be defined by the components below the cooking chamber 24 such as those components below an underside of the rotating tray 134, a lower portion of the outer shell 22 and the lower panel 30. The lower oven portion 20 may include the axle 42 that may be directly coupled to the underside of the rotating tray 134 at a center of the rotating tray such that the axle 42 defines the axis 135 along its longitudinal length and extends vertically and centrally through the outdoor oven 10. In this manner, such axis 135 may extend through the upper and lower stones 126, 132 and may extend perpendicular relative to the upper and lower stones, the upper and lower stones positioned to be substantially parallel relative to each other. Further, upon removing or re-positioning the oven portion 14 relative to the stand portion 16, the oven portion may be moveable along the axis 135, as depicted by the bi-directional arrows 15 in FIG. 3.

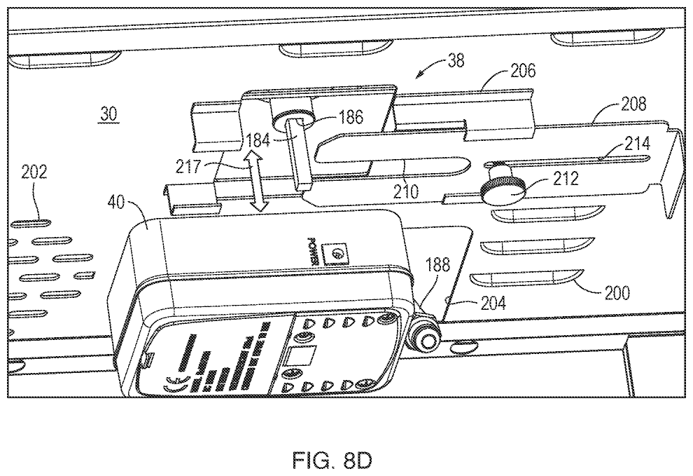

Now with reference to FIGS. 5A, 5B, 6 and 7, the oven portion 14 may include a thermometer 174 that may be located on the front side 72 of the outer shell 22 below the lip 124 of the chamber opening 84 (FIG. 5). The upper oven portion 18 may include a lower side panel (or shell floor 26) extending from the front side 72, left side 74, back side 76, and right side 78 over the inner portion 28 of the lower oven portion 20. The lower side panel or shell floor 26 may be in addition to, or instead of, the upper panel 61 (see FIG. 4) of the lower oven portion 20. The lower side panel 26 may include a burner opening 176 sized and configured to allow for the burner 60 to be located at least partially below or underneath such that the region in which a flame is produced from the burner 60 may be above or directly adjacent the burner opening 176 and the burner 60. The burner 60 may be located in the inner portion 28 of the lower oven portion 20. The lower side panel or shell floor 26 may also include an upper opening 180 sized and configured to allow the axle 42 to extend from the lower oven portion 20 into the upper oven portion 18. Further, the upper opening 180 may include a reinforcement structure 182 sized and configured to reinforce the upper opening 180 and axle 42. The reinforcement structure 182 may be located in the inner portion 28 of the lower oven portion 20 and may include first and second bearings 183, 185 and a bushing 187 spaced along a length of the axle 42 to stabilize and maintain the axle 42 to be aligned within the upper opening 180. As such, as the motor 40 rotates the axle 42 and the tray 134, as shown by rotational arrow 189, the reinforcement structure 182 with its first and second bearings 183, 185 and bushing 187 arrangement assists in maintaining the axis 135, defined by the axle 42, in a substantially fixed position. The lower oven portion 20 may include the lower panel 30 extending from the front panel 52, left panel 62, rear panel 64, and right panel 66. The lower panel 30 may extend to define an interior surface 32 and an exterior surface 34 such that the interior surface 32 may be located within the inner portion 28 of the lower oven portion 20. The lower panel 30 may extend to define the lower opening 36 extending into the inner portion 28. Further, the exterior surface 34 may extend to define and include the holding system 38 coupled thereto, sized and configured to secure the motor 40 to the exterior surface 34 of the lower panel 30. Even further, the lower opening 36 may be sized and configured to allow a drive shaft 184 from the motor 40 to extend into the inner portion 28 such that the drive shaft 184 may connect with the axle 42. The axle 42 may include a shaft insert 186 (FIG. 8D) sized and configured to allow for the drive shaft 184 to be slid into the axle 42. The motor 40 may be connected to the axle 42 through the drive shaft 184 so the motor 40 may turn the axle 42 and tray 134. The drive shaft 184 and axle 42 may extend through the lower opening 36 into the inner portion 28 and through the upper opening 180 and to an underside of the cooking chamber 24.

The front panel 52 of the lower oven portion 20 may include a gas line 188 (and associated structural components) extending from the front panel 52 to below the lower panel 30 such that a propane tank or natural gas may be operatively connected to the gas line 188. In one embodiment the upper oven portion 18 and lower oven portion 20 may be spaced from each other with one or more panels therebetween, such as the lower side panel 26, so as to define a spaced gap 190 between the upper and lower oven portions 18, 20. The upper oven portion 18 may be suspended above the lower oven portion 20 with, for example, multiple spacers 191 so that the spaced gap therebetween facilitates air flow between the upper and lower oven portions 18, 20. Further, the lower oven portion 20 may include a component heat shield 193 that may exhibit an L-shaped cross-section, as depicted in FIG. 5B, so that the component heat shield 193 extends with horizontal and vertical components to protect the various functional components of the lower oven portion 20. In this manner, such spaced gap 190 and the component heat shield 193 may facilitate the temperature of the lower oven portion 20 to be minimized so that the life span of the various functional components within and associated with the lower oven portion 20, such as the burner knob and components associated therewith, may be prolonged. The overhang 164 of the lower heat shield 130 may extend towards the front side panel 72 of the outer shell 22 such that a thermometer space 192 may be defined below the overhang 164 and between the lower heat shield 30 and the front side panel 72. Other locations for a thermometer on the oven portion 14 may also be suitable.

The cover 80 may include multiple walls (or a dual wall arrangement), such as an exterior wall 195 and an interior wall 197 to define a cover air gap 198 between the multiple walls. Such multiple walls forming the cover 80 may assist in minimizing the temperature of the exterior wall 195 of the cover 80 due to the heat produced by the burner 60. The shell floor 26 may be sized and configured to completely extend over the inner portion 28 of the lower oven portion 20 to minimize heating the lower oven portion 20. Further, the shell floor 26 may extend to be connected to the lower heat shield 130 such that the shell floor 26 and lower heat shield 130 may act to funnel or direct convection heat towards the cooking chamber 24 and tray 134, as shown by arrow 137 in FIG. 5A. Even further, the lower heat shield 130 may be sized and configured to minimize the temperature of the outer shell 22. The upper heat shield 128 may be sized and configured to direct convection heat, as shown by arrow 137, towards the upper stone 126 such that the upper stone 126 may retain heat (act as a heat sink) to then radiate heat towards the lower stone 132, as shown by arrow 139 in FIG. 5A. Further, as the tray 134 rotates and is heated, the heat conducts through the underside of the tray 134 and into the lower stone 132, which then radiates heat upward toward the upper stone 126. In this manner, the upper heat shield 128 and the lower heat shield 130 directs the heat into the cooking chamber 24 and minimizes heat loss toward the outer shell 22 with the upper and lower air gaps 129, 139 such that the temperature of the outer shell 22 may be minimized.

Now with reference to FIGS. 8, 8A, 8B, 8C and 8D, the lower floor 30 of the lower portion 20 extends from the front panel 52, rear panel 64, left panel 62, and right panel 66. The lower floor 26 may extend to define elongated vents 200 and burner vents 202. The elongated vents 200 may be located along the exterior 34 of the lower floor 30 such that oxygen may be drawn into the inner portion 28 (FIG. 5A). The burner vents 202 may extend on the exterior 34 of the lower floor 30 directly beneath the burner 60 (FIG. 5A) such that air or oxygen may access the burner 60 (FIG. 5A) through the lower floor 30 and into the inner portion 28. The lower floor 26 may extend to define a gas line opening 204 sized and configured to allow the gas line 188 to exit the inner portion 28 (FIG. 4) from the front panel 52 to the exterior 34 of the lower floor 26. Further, the lower floor 26 may extend to define a holding system 38. The holding system 38 may include one or more L-brackets 206 and a sliding mechanism 208. The sliding mechanism 208 may define a channel 210 therein, button screw 212, and a button channel 214 therein. The channel 210 may be sized and configured to slide past the drive shaft 184 and connect to the motor 40. The button screw 212 may be sized and configured to hold the sliding mechanism 208 in place. Further, the button screw 212 may unscrew, as shown by arrow 213, from its place and loosen from the sliding mechanism 208, as depicted in FIGS. 8A and 8B). The button channel 214 may slide past the loosened button screw 212, as shown by arrow 215, such that the sliding mechanism 208 and channel 210 may slide away from the motor 40. The motor 40 may then be removed from the holding system 38, as depicted by arrow 217 in FIG. 8D. In a similar manner, the motor 40 may be assembled by coupling the drive shaft 184 of the motor 40 to the axle 42 via the shaft insert 186. The sliding mechanism 208 may then be moved through the L-brackets 206 so that the channel 210 is aligned with the drive shaft 184 and the button channel is aligned with the button screw 212. In this manner, the motor may be dis-assembled and assembled with the axle 42 of the oven portion 14 (FIG. 5A).

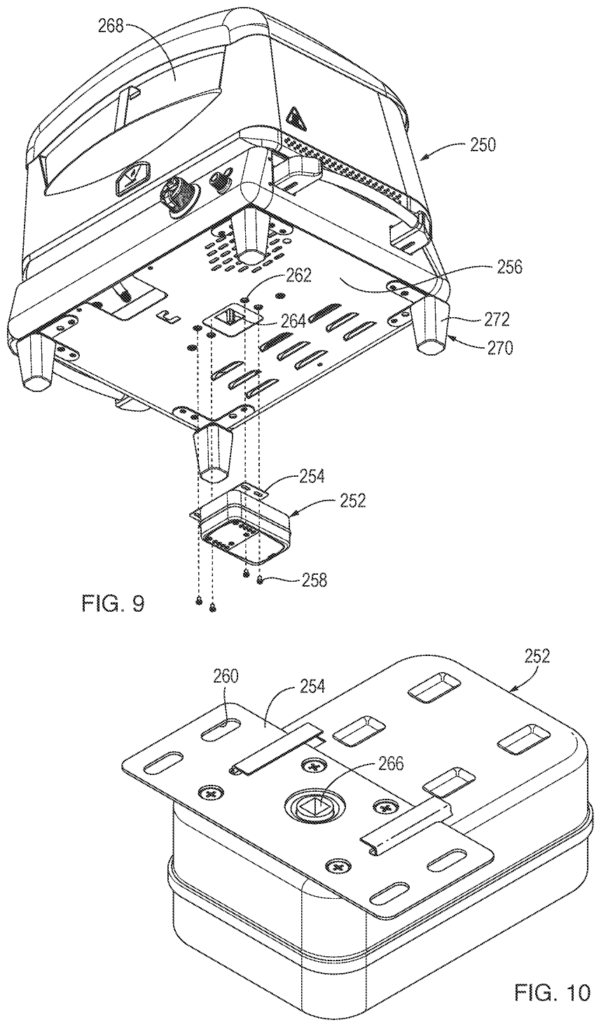

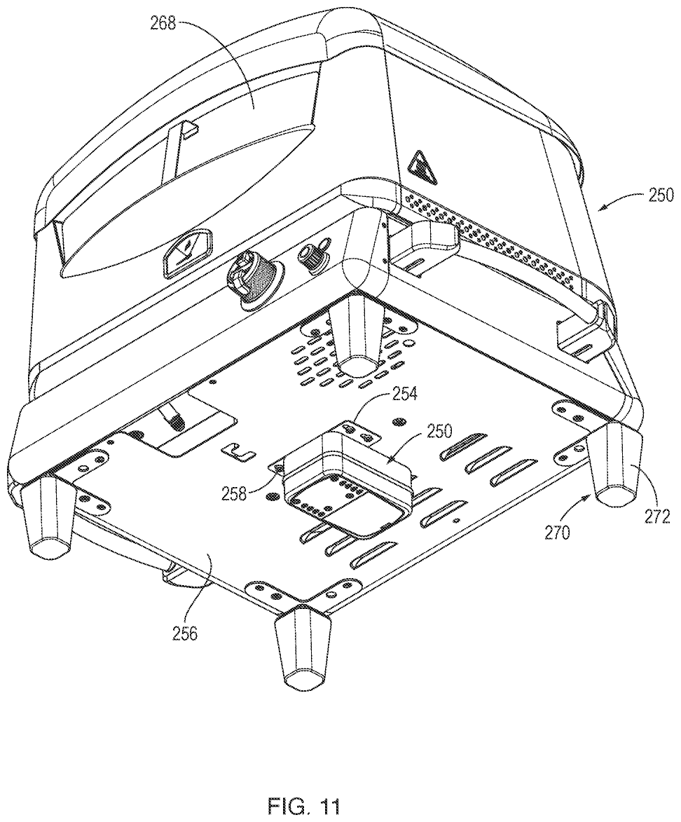

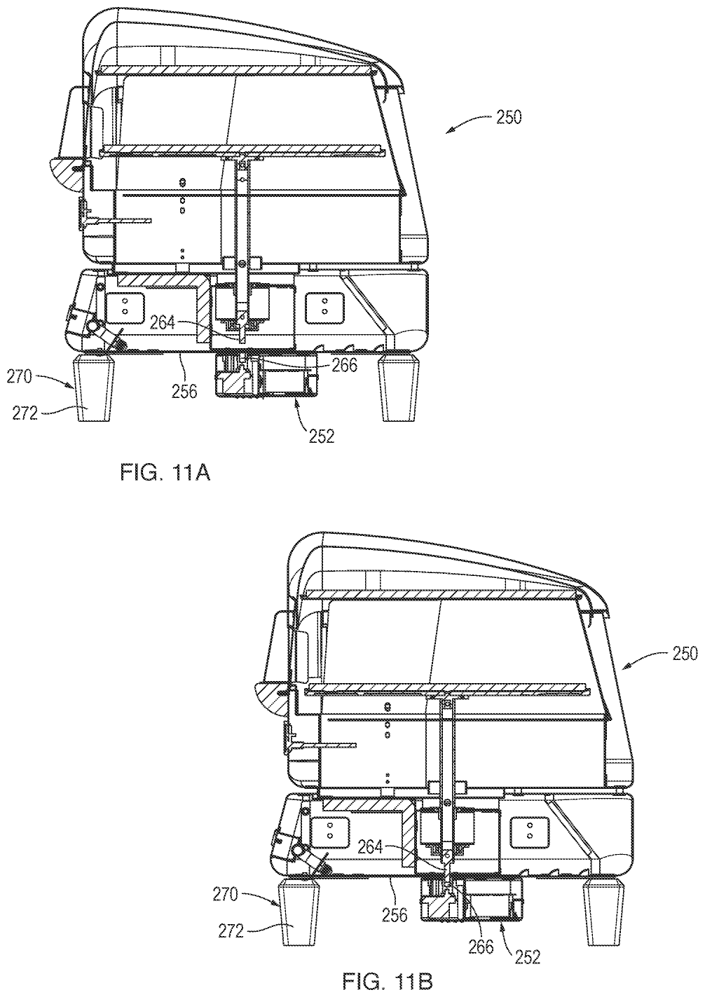

With reference to FIGS. 9, 10, 11A, and 11B, another embodiment of an electrical motor 252 with structure for attaching the motor 252 to an underside of an oven portion 250. The oven portion 250 of this embodiment may be substantially similar to the oven portion of the previous embodiment and may be similarly configured to be coupled to a stand portion (not shown) as depicted in FIGS. 1 and 3 of the previous embodiment. In one embodiment, the motor 252 may include a flange 254 that may facilitate attaching the motor 252 to a bottom side 256 of the oven portion 250 with fasteners 258, the fasteners 258 configured to extend through flange holes 260 to be attached to panel holes 26 along the bottom side 256 of the oven portion 250. Upon loosely fastening the motor 252 to the bottom side 256 of the oven portion 250, a drive shaft 264 of the oven portion 250 may be lowered into a drive shaft receiver 266 defined in the motor 252, as depicted in FIGS. 11A-11B. Upon the drive shaft 264 being fully engaged with the drive shaft receiver 266, the fasteners 258 may then be tightened so that the motor 252 may be secured to the bottom side 256 of the oven portion 250. In another embodiment, the oven portion 250 may include a removable front cover 268 sized and configured to cover the access opening of the baking chamber. Further, in another embodiment, the oven portion 250 may include removable leg covers 272 that may be formed from a polymeric material so that, upon moving the oven portion 250 from a stand, such as stand portion 16 of FIG. 3, oven legs 270 of the oven portion 250 may be covered with the leg covers 272 to protect the surface the oven portion may be positioned upon.

The various structural components of the various embodiments of the outdoor oven 10 set forth herein and any other structural components thereof may be formed of various metallic materials, such as steel, stainless steel, copper, aluminum or any other suitable material with high temperature ratings, such as various suitable polymeric materials, and may be formed from known structural components, such as sheet metal at various gauges/thicknesses or other known metallic structures, such as tubing or the like, and may be formed and manufactured through various known processes and techniques known in the art, such as casting, welding, rolling, bending, pressing, fastening, etc., as known by one of ordinary skill in the art.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. An outdoor oven with temperature control, the outdoor oven comprising:
an upper oven portion with an outer shell extending to surround a cooking chamber, the cooking chamber defined by an upper stone, a lower stone and a heat shield, the heat shield extending downward from the upper stone to partially surround a periphery of the lower stone, the heat shield positioned within the outer shell such that a gap is defined between the heat shield and the outer shell, the outer shell including a shell floor extending between opposing sides of a lower end of the outer shell, the shell floor including a burner opening defined therein, and the heat shield extending toward the shell floor, the outer shell extending to define a front opening sized to access the cooking chamber, the outer shell including multiple vent holes defined therein and adjacent the lower end of the outer shell, the vent holes sized and configured to draw air into the gap defined between the heat shield and the outer shell; and
a lower oven portion including a burner knob coupled thereto, the burner knob coupled to a burner such that the burner is positioned at least partially below the burner opening defined in the lower floor of the upper oven portion, the lower oven portion positioned below the upper oven portion with a spaced gap therebetween such that the spaced gap is sized to minimize heating the lower oven portion.

2. The outdoor oven of claim 1, wherein the heat shield comprises an upper heat shield and a lower heat shield, the lower heat shield positioned below the lower stone with the upper heat shield extending upward directly from the lower heat shield.

3. The outdoor oven of claim 2, wherein the lower heat shield is positioned on the shell floor and extends with a band configuration, the upper heat shield having a partial truncated cone shape positioned over the lower heat shield.

4. The outdoor oven of claim 1, wherein the upper oven portion comprises a cover, the cover positionable over the outer shell.

5. The outdoor oven of claim 1, wherein the upper oven portion comprises a cover, the cover including a dual wall with a cover gap defined therebetween, the cover extending above the outer shell and the upper stone.

6. The outdoor oven of claim 1, wherein the burner is configured to burn fuel so that heat flows upward against the lower stone and through a heat gap between the periphery of the lower stone and the heat shield to flow into the cooking chamber to heat the upper stone.

7. The outdoor oven of claim 1, wherein the lower stone is configured to rotate with a motor associated with the lower housing, the lower stone positioned on a tray with an axle extending between the motor and the tray.

8. The outdoor oven of claim 1, wherein the heat shield comprises a stainless-steel material.

9. The outdoor oven of claim 1, wherein the upper oven portion is suspended above the lower oven portion with spacers to define the spaced gap therebetween.

10. A cooking system with modifiable portability, comprising:
an outdoor oven extending with an upper oven portion and a lower oven portion, the upper oven portion including the cooking chamber having a lower stone positioned on a rotatable tray, the tray rotatable about an axis, the lower oven portion including oven legs extending therefrom; and
a stand including a frame structure extending between an upper side and a lower side, the frame structure sized and configured to receive the oven legs of the outdoor oven so that the outdoor oven is positionable over the stand, the stand including wheels positioned adjacent the lower side of the stand, the outdoor oven being removable from the frame structure of the stand to separate the outdoor oven from the stand so that the outdoor oven is useable in a countertop configuration.

11. The cooking system of claim 10, wherein, upon the outdoor oven being positioned on the stand, the outdoor oven is removable by moving the outdoor oven upward along the axis.

12. The cooking system of claim 10, wherein, upon the outdoor oven being positioned on the stand, the outdoor oven is prevented from being moved laterally relative to the axis.

13. The cooking system of claim 10, wherein the outdoor oven extends with an upstanding outer panel and a cover, the cover positioned over the upstanding outer panel so as to define a chamber opening for accessing the cooking chamber, the cover extending with a cover exterior wall and a cover inner wall with a cover space defined therebetween, the cover inner wall and the cover space sized and configured to minimize heating the exterior wall.

14. The cooking system of claim 10, wherein the upper oven portion extends with an outer shell having a shell floor, the upper oven portion including an upper heat shield and a lower heat shield to minimize heating the outer shell, the upper heat shield at least partially defining the cooking chamber, the upper heat shield extending to partially surround a periphery of the lower stone and extending to overlap a portion of the lower heat shield such that the lower heat shield is positioned along the shell floor.

15. The cooking system of claim 10, wherein the upper oven portion extends with an outer shell, the upper oven portion including a heat shield positioned to provide a gap defined between the outer shell and the heat shield, the outer shell defining multiple vent openings defined therein adjacent a lower end of the outer shell, the multiple vent openings sized and configured to draw air therethrough and into the gap to cool the outer shell of the upper oven portion.

16. The cooking system of claim 10, the lower oven portion positioned below the upper oven portion with a spaced gap defined therebetween such that the spaced gap is sized to minimize heating the lower oven portion.

17. A method of modifying portability of an outdoor oven, the method comprising:
providing the outdoor oven extending with an upper oven portion and a lower oven portion, the upper oven portion including the cooking chamber having a lower stone positioned on a rotatable tray, the tray rotatable about an axis, the lower oven portion including oven legs extending therefrom;
positioning the outdoor oven over a stand such that the oven legs are receivable by frame structure of the stand to maintain the outdoor oven in an elevated position on the stand; and
separating the outdoor oven from the stand by moving the outdoor oven upward along the axis so that the outdoor oven is useable in a countertop configuration.

18. The method according to claim 17, wherein the positioning comprises moving the stand with the outdoor oven positioned thereon with wheels coupled to a lower end of the stand.

19. The method according to claim 17, further comprising heating the cooking chamber for cooking with the outdoor oven such that the outdoor oven is either (1) coupled to the stand in the elevated position, or (2) separated from the stand with the outdoor oven in the countertop configuration.

20. The method according to claim 17, wherein the providing comprises providing the upper oven portion suspended above the lower oven portion with a spaced gap defined therebetween, the spaced gap configured to minimize heating components of the lower oven portion.
